(19) United States
(12) Patent Application Publication
(10) Pub. No.: US 2008/0103633 A1
(43) Pub. Date: May 1, 2008

(54) DIGITALLY IMPLEMENTED POWER SUPPLY SUPERVISORIES

(76) Inventors: Gunnar R. Holmquist, Santee, CA (US); Daniel D. Zuck, Escondido, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/562,821

(22) Filed: Nov. 22, 2006

Related U.S. Application Data
(60) Provisional application No. 60/854,996, filed on Oct. 27, 2006.

(51) Int. Cl. G05F 5/00

(52) U.S. Cl. 700/293; 700/298

(57) ABSTRACT

Power supplies include digital supervisory circuits that detect faults and control power supply operation. The supervisory control algorithms are user programmable so that the supervisory function can be easily manipulated by the power supply user for different applications of the power supply.

### CROSS REFERENCE TO RELATED APPLICATIONS

This application claims priority under 35 U.S.C. Section 119(e) to U.S. Provisional Application 60/854,996, entitled Digitally Implemented Power Supply Supervisories, filed on Oct. 27, 2006.

### BACKGROUND OF THE INVENTION

1. Field of the Invention

The invention relates to operation and control of programmable power supplies.

2. Description of the Related Technology

Power supplies having user programmable output are utilized in a variety of environments, often providing power to test and/or validate the operation of electrically powered equipment.

In these applications, it is important for the power supply to sense and respond to unexpected loads or fault conditions in a manner that minimizes the potential for damage to the power supply and/or the equipment the power supply is providing power to.

In conventional programmable power supplies, various sensors are provided that sense electrical parameters such as output voltage, output current, temperature, air-flow, and the like. The outputs of these sensors are typically routed to an analog circuit that produces a control output controlling power supply operation by, for example, shutting down the power supply or changing the output regulation.

These analog control circuits are inherently inflexible in operation, since their characteristics are difficult or impossible to change once a power supply is put to use.

### SUMMARY OF CERTAIN INVENTIVE ASPECTS

The system, method, and devices of the invention each have several aspects, no single one of which is solely responsible for its desirable attributes. Without limiting the scope of this invention, its more prominent features will now be briefly discussed.

In one embodiment, the invention comprises a power supply having a programmable output voltage and/or output current and a plurality of digital supervisory controls. In this embodiment each control is configured to process one or more inputs using a plurality of control parameters to produce a control output affecting the output voltage and/or output current.

In another embodiment, the invention comprises an over-current protection system for a power supply comprising an output current sensor, an analog to digital converter configured to digitize an output of the sensor, a user programmable filter configured to filter an output of the analog to digital converter, a memory storing one or more user programmable thresholds, and comparison circuitry configured to compare an output of the user programmable filter with the one or more user programmable thresholds.

In another embodiment, a method of controlling operation of a power supply comprising a plurality of sensors for monitoring operation of the power supply is provided. The method comprises programming one or more digital signal processing parameters and one or more decision making parameters into one or more memory locations in the power supply. Sensor output data is processed with digital signal processing circuitry configured with the digital signal processing parameters. Processed sensor output data is compared with comparison circuitry configured with the decision making parameters. Decision outputs are produced based on the comparing.

### BRIEF DESCRIPTION OF THE DRAWINGS

FIG. 1 is a block diagram of a programmable power supply in accordance with one embodiment of the invention.

FIG. 2 is a block diagram of a set of digital control supervisories.

FIG. 3 is a graph of typical output current as a function of time for an AC power supply powering a rectifier-capacitor load impedance.

FIG. 4 is a flow chart of signal processing and control decision making for a digital supervisory implementing overcurrent protection in an output current environment as illustrated in FIG. 3.

FIG. 5 illustrates the controlled parameters of the flow chart of FIG. 4.

### DETAILED DESCRIPTION OF CERTAIN INVENTIVE EMBODIMENTS

Various aspects and features of the invention will become more fully apparent from the following description and appended claims taken in conjunction with the foregoing drawings. In the drawings, like reference numerals indicate identical or functionally similar elements. In the following description, specific details are given to provide a thorough understanding of the disclosed methods and apparatus. However, it will be understood by one of ordinary skill in the technology that the disclosed systems and methods may be practiced without these specific details. For example, electrical components may be shown in block diagrams in order not to obscure certain aspects in unnecessary detail. In other instances, such components, other structures and techniques may be shown in detail to further explain certain aspects.

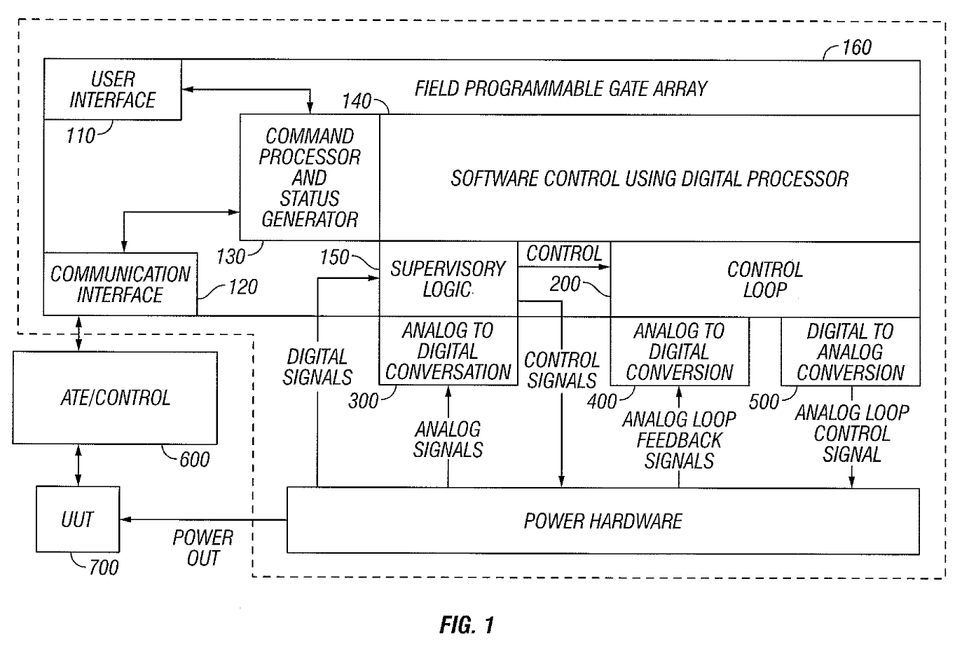

FIG. 1 is a block diagram of a power supply according to one embodiment of the invention. The power supply comprises a power supply digital control 160 and power hardware 600. The power supply digital control 160 may include a user interface 110, a communication interface 120, a command processor/status generator 130, a digital processor for running control software, supervisory logic 150, and a control loop 200, which in one exemplary embodiment may be partly or wholly implemented in a field programmable gate array. The power supply digital control further includes data converters. The data converters may include a first analog-to-digital converter (ADC) unit 300, a second ADC unit 400, and a digital-to-analog converter (DAC) unit 500.

The command processor/status generator 130 is connected to the user interface 110 and to the communication interface 120. The command processor/status generator 130 is connected to the digital processor 140 for software control. Both the supervisory logic 150 and the control loop 200 are connected to the digital processor 140. The first ADC unit 300 is connected to the supervisory logic 150, and the second ADC unit 400 and the DAC unit 500 are connected to the control loop 200.

In operation, the command process/status generator 130 receives programmable values including a reference voltage (Vref) and/or a reference current (Iref) through the user interface 110 or the communication interface 120. In a preferred embodiment, either or both of the reference voltage and the reference current may be programmed by a user. Alternatively, the reference voltage and/or the reference current may be dynamically programmed by control software that may run inside or outside the power supply digital control. The power supply digital control is configured to provide a control signal that causes the power hardware to operate at a programmed output. This may be done in some advantageous embodiments by selectively employing digital feedback loops—a voltage feedback loop and a current feedback loop—inside the control loop 200. Digital feedback loops for programmable voltage and current source power supplies are described in additional detail in U.S. patent application Ser. No. 11/541,439, entitled Power Supply with Digital Feedback Loop and U.S. patent application Ser. No. 11/540,938, entitled AC Output Power Supply with Digital Feedback Loop, both filed on Sep. 28, 2006 and incorporated by reference herein in their entireties.

As illustrated in FIG. 1, the supervisory logic 150 receives digital signals either directly from the power hardware 600 and/or from analog to digital converter unit 300 that takes analog inputs from the power hardware and converts them to digital signals for digital processing by the supervisory logic 150. At least some of the digital signal processing performed by the supervisory logic 150 is advantageously programmable either at the factory during power supply production, in the field by the user of the power supply, or both. In most implementations, some parameters may be fixed by the hardware design, some processing parameters will be only factory configurable, and some will be configurable both in the field and at the factory. In most embodiments, and as explained further below, the digital processing performed by the supervisory logic 150 may be configured at least in part by the user with user programmable parameters through the communication interface 120 or user interface 110. This provides flexibility for the user to determine what control signal outputs are generated and under what conditions. Such flexibility has not previously been provided in programmable power supplies. It is especially advantageous for the general nature of the processing to be controlled by factory defined general processing algorithms that have particular parameters that are user controllable through a GUI or other programming means. This provides both a user friendly interface and flexible power supply response to supervisory inputs.

FIG. 1 illustrates the digital control and processing as implemented in combinatorial and sequential logic, one example of which is a field programmable gate array, and this is one possible implementation. It will be appreciated that a wide variety of implementations are possible. The digital functions may, for example, be implemented in firmware executed by a microprocessor or digital signal processor. Discrete logic hardware may also be utilized for some or all functions. In addition, it will be appreciated that some of the functions described below can be performed in the analog domain. As used herein, the term “digital control supervisory” refers to a power supply control system where at least some, but not necessarily all, of the processing performed during control operation is done with digital signal processing techniques. It is generally advantageous, however, to perform most or all of the control processing in the digital domain.

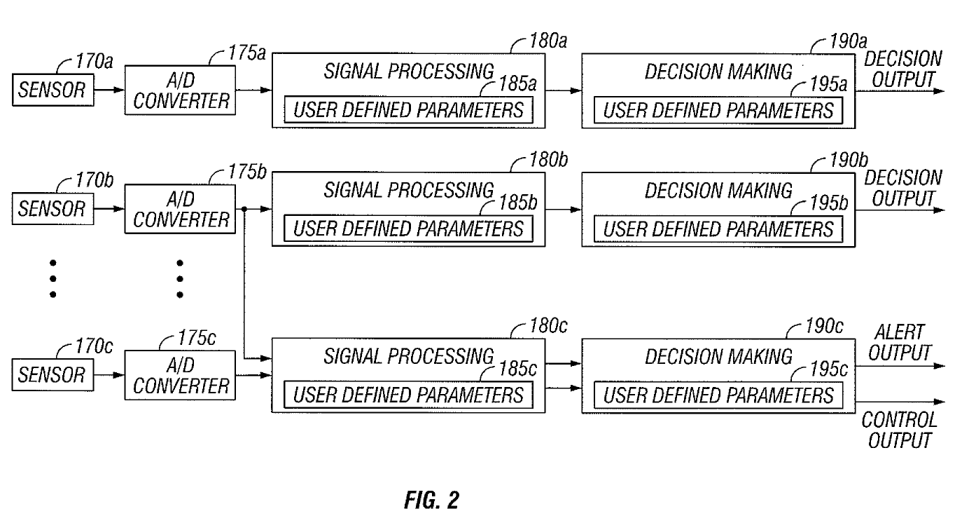

FIG. 2 is a block diagram of one embodiment of digital supervisory processing in a power supply. A plurality of sensors 170a-170c provide analog output signals representative of some particular aspect of the power supply performance or operation. The sensors may sense a wide variety of operational and environmental parameters. Two important sensed parameters would typically be output voltage and output current. Input voltage and current to the power supply can also be monitored for fault conditions. Sensed environmental parameters can include temperature inside the power supply and airflow detected from fan operation. Internal power hardware function can be monitored for faults, including proper operation of the inner and outer control loops and the output inverter. The above list is not in any way an exhaustive list of possible monitored conditions. A wide variety of conditions can be sensed and used to produce an analog signal representing some aspect of power supply condition or performance.

The analog signals representing sensed operational conditions are converted to digital signals with analog to digital converters 175a-175c.

The production of control outputs from the digital signals can generally be broken up into two processing stages. First, there is a signal processing stage 180a-180c followed by a decision making stage 190a-190c for each digital signal. In many advantageous embodiments of the invention, the processing performed in both the signal processing and decision making stages is performed under the control of user defined parameters 185a-c and 195a-c.

In the signal processing stage 180, the user may be allowed to program different filtering functions that are applied to the incoming digital signal. Signal offsets or slicing functions may in some cases be user defined. In the decision making stage 190, the user may be able to program different thresholds that the processed signal is compared to. As shown in blocks 180c and 190c, signal processing and decision making could be performed on multiple inputs, and may produce multiple outputs. An example of such an embodiment is described below.

In some embodiments, a user interface may be provided that allows full user control of processing and decision making for all sensor outputs. Such an embodiment could utilize programmable DSP, microcontroller, or other programmable microprocessing logic that takes any set of sensor inputs and produces any set of decision outputs based on user written software code. In other embodiments, basic signal processing and decision functions are pre-defined, and the user can program in desired timing, filter, and comparison threshold parameters.

Digitizing sensor outputs and allowing user programmability of signal processing and decision making allows flexible power supply operation in a variety of applications that has heretofore been unavailable.

### EXAMPLE 1

### Output Over-Current Protection

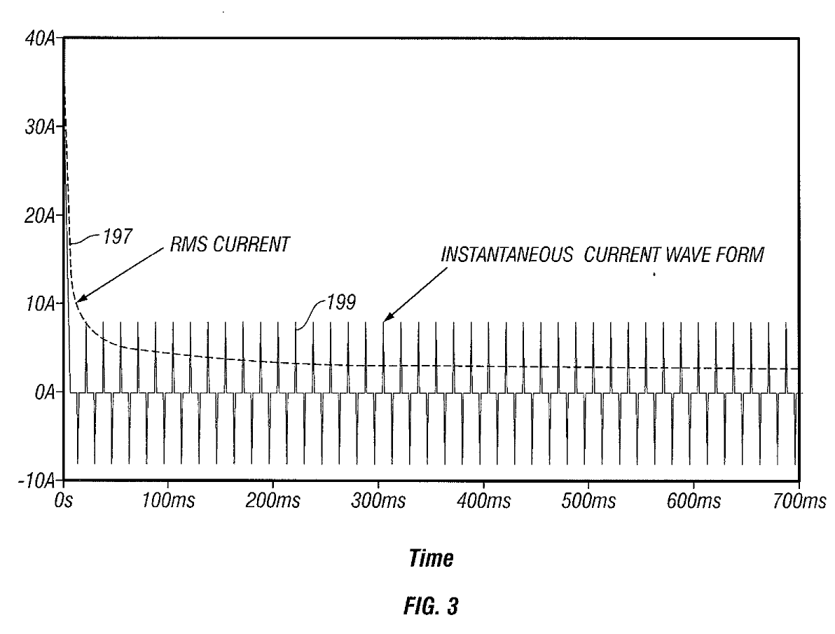

AC power supplies are typically configured to provide over-current protection such that if the current being provided to a load exceeds a threshold, the power supply shuts off its output or otherwise limits the current being provided to the load. However, the power supply should not indicate a fault condition or shut down under normally expected load current transients such as inrush events. This is a typical surge current when closing the power-on switch for equipment with a rectifier-capacitor input stage characterized by a high initial current, and quickly tailing off as the output capacitor charges up. This is illustrated by trace 197 in FIG. 3, which shows the RMS current delivered to the load as a function of time after power on. Trace 199 shows the instantaneous current level, illustrating the peaks separated by 8.3 ms (60 Hz sine wave applied to the load) that occur when the rectifier becomes conductive and charges the output capacitor of the load. The AC source is required to supply this high inrush current without tripping its over-current protection supervisory. However, if the initial peak current were to remain at this high level for too long, the AC source and unit under test could both be damaged.

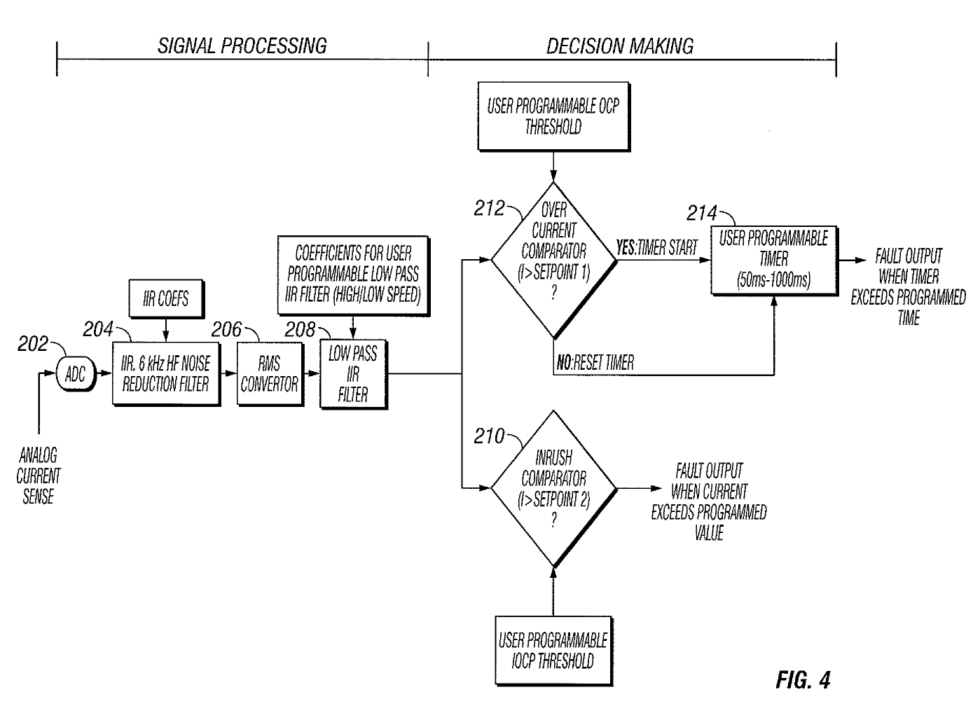

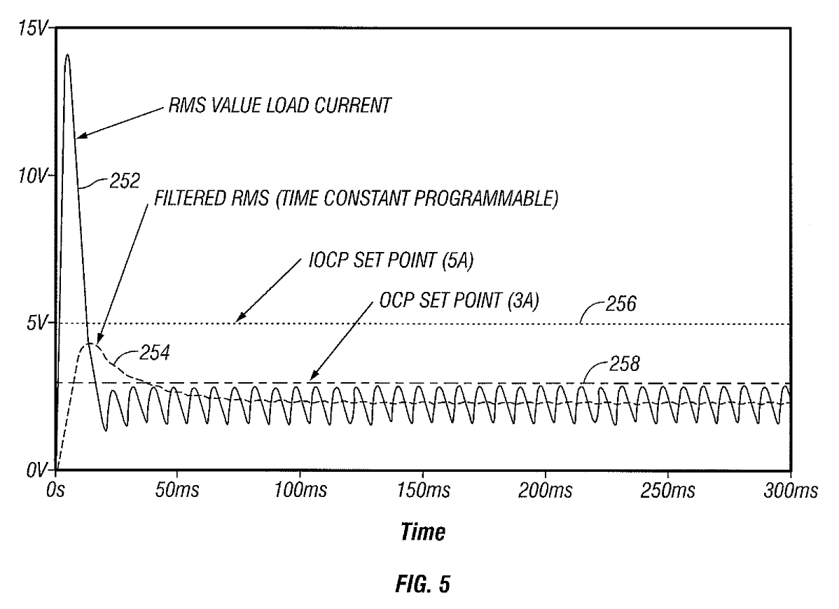

FIGS. 4 and 5 illustrate user programmable signal processing and decision making for an output over-current protection supervisory. In this embodiment, the user has programmable control over a set of four programmable parameters to tailor current-protection. These are referred to as the OCP setpoint, which is the main current protection limit (continuous value); the IOCP setpoint which is the inrush current protection limit (max value); the OCFILTER setpoint which defines the low pass filter function (applied to RMS value) in the signal processing stage; and the TOCP setpoint which is a timer that allows the OCP to be exceeded for a pre-defined period before triggering the fault output.

FIG. 4 shows a block diagram of the over-current protection algorithm. The first section is signal processing. The ADC 202 is sampling load current. The first IIR filter 204 removes high frequency noise, which improves accuracy of current measurement. In this embodiment, this filter is fixed and is not user programmable, but of course this need not be the case. The RMS converter 206 may be continuously updated at the sample rate as described in co-pending patent application Ser. No. 11/541,439, entitled AC Output Power Supply with Digital Feedback Loop, filed on Sep. 28, 2006 referred to above. The period defining the number of samples included in the RMS calculation may be fixed or user controllable. A graph of a typical output from the RMS converter 206 is shown as trace 252 on FIG. 5. The low pass IIR filter 208 is user programmable to filter the RMS value. A graph of a typical output from the low pass filter 208 is shown as trace 254 on FIG. 5.

The second section is decision-making with programmable OCP and IOCP setpoints, and programmable TOCP timer. The output of the low pass filter 208 is compared to the IOCP set point (shown as line 256 in FIG. 5) in comparator 210. If this setpoint is exceeded, a fault decision output is produced. The output of the low pass filter 208 is also compared to the OCP set point (shown as line 258 in FIG. 5) in comparator 212. If this setpoint is exceeded, a timer 214 is started. If the timer value exceeds the TCOP setpoint, a fault decision output is produced. If the filtered RMS value drops back below the OCP setpoint prior to the timer reaching the TCOP setpoint, the timer is reset. Thus, the filtered version of the current is allowed to have excursions above the OCP setpoint, but below then IOCP setpoint, but only for time periods less than the time period defined by TOCP. If either IOCP or TOCP are exceeded, the AC source control logic will detect an over-current condition, and take appropriate action such as shutdown or current limit, as configured by the user.

The flexibility of this over-current protection allows for very fast protection by making the filter time constant fast, the IOCP level close to the OCP level, and setting the TOCP timer to its minimum value.

### EXAMPLE 2

### Airflow Fault Protection

Some power supplies are configured to produce a fault signal if a cooling fan fails. In one embodiment, this feature can be made more flexible for the user with an implementation of the invention.

Referring back to FIG. 2, sensor 170b may be an output current sensor, and sensor 170c may be an airflow or fan operation sensor. The outputs of both A/D converters 175b and 175c for these sensors are routed to signal processing block 180c where the signals may be filtered or other wise processed according to user defined parameters as described above.

In decision making block 190c, a decision process may be performed that first looks to the airflow or fan operation signal to determine if operation is normal. If it is not normal, the decision block can determine if the current is above a user defined threshold such as 25% or 50% of rated maximum output current. If the current is above this threshold, a control output is produced to shut down the output as configured by the user. If the current is below the threshold, normal operation can continue given the fact that the lack of airflow is not a concern if the output current is sufficiently low. In this case, an alert output may be generated to indicate the fan problem without causing any change in power supply output.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A power supply comprising:
a programmable output voltage and/or output current;
a plurality of digital supervisory controls, each control being configured to process one or more inputs using a plurality of control parameters to produce a control output affecting said output voltage and/or output current.

2. The power supply of claim 1, wherein each input comprises a digital signal.

3. The power supply of claim 1, comprising one or more analog-to-digital converters configured to convert analog signals into digital signals.

4. The power supply of claim 1, wherein the response time of at least one supervisory control is user programmable.

5. The power supply of claim 1, wherein one or more of the supervisory controls is programmable.

6. The power supply of claim 1, wherein one or more of the supervisory controls comprises an infinite impulse response (IIR) filter having one or more programmable coefficients.

7. The power supply of claim 1, wherein at least one of the supervisory controls is configured to protect the power supply device from unanticipated loading conditions.

8. The power supply of claim 7, wherein the unanticipated loading conditions comprises at least one of the following: overvoltage, undervoltage, overcurrent.

9. The power supply of claim 1, wherein said control output is produced in response to at least one condition selected from overvoltage, undervoltage, overcurrent, overtemperature, paralleling ground fault, airflow fault, and overpower.

10. The power supply of claim 1, wherein said control supervisories are implemented in combinatorial and sequential logic.

11. The power supply of claim 1, wherein said control supervisories are implemented in a microprocessor executing instructions stored in a memory.

12. The power supply of claim 1, wherein said control supervisories are implemented in a field programmable gate array.

13. An overcurrent protection system for a power supply comprising:
an output current sensor;
an analog to digital converter configured to digitize an output of said sensor;
a user programmable filter configured to filter an output of said analog to digital converter;
a memory storing one or more user programmable thresholds;
comparison circuitry configured to compare an output of said user programmable filter with said one or more user programmable thresholds.

14. The system of claim 13 comprising a user programmable timer.

15. A method of controlling operation of a power supply, said power supply comprising a plurality of sensors for monitoring operation of said power supply, said method comprising:
with a user interface, programming one or more digital signal processing parameters into one or more memory locations in said power supply;
with a user interface, programming one or more decision making parameters into one or more memory locations in said power supply;
processing sensor output data with digital signal processing circuitry configured with said digital signal processing parameters;
comparing processed sensor output data with comparison circuitry configured with said decision making parameters; and
producing decision outputs based on said comparing.
